(19) United States
(12) Patent Application Publication
(10) Pub. No.: US 2023/0181407 A1
(43) Pub. Date: Jun. 15, 2023

(54) Blood Circulation Enhancement Method and Apparatus

(71) Applicant: Matthew James Humiston, Redondo Beach, CA (US)

(72) Inventor: Matthew James Humiston, Redondo Beach, CA (US)

(21) Appl. No.: 17/546,233

(22) Filed: Dec. 9, 2021

(51) Int. Cl. A61H 1/02

(52) U.S. Cl. CPC A61H 1/0274; A61H 2201/1652; A61H 2203/0487; A61H 2201/1276; A61H 2201/14

(57) ABSTRACT

This invention pertains to therapeutic or medical devices to improve healing, performance, or aesthetics by enhancing blood circulation to regions of the body. Blood circulation is enhanced using gravity by gradually raising and lowering the body member slowly and repeatedly from a level below the heart to a level above the heart.

### BACKGROUND OF THE INVENTION

This invention relates to an apparatus to enhance blood circulation to a region of the body for the purpose of healing, improved performance, or aesthetic improvement.

A body's healing, nutrition, waste removal, and the body's immune system's response to infections is achieved through blood circulation to the affected region of the body. Increasing blood circulation will enhance all of these bodily functions. Blood circulation can be increased by repeatedly raising the affected body member from a level above the heart for a period of time sufficient to allow blood to drain from the body member followed by lowering the body member to a level below the heart for a period of time sufficient for the blood to circulate back into the body member.

Currently there exists devices to suspend body parts above the level of the heart to reduce swelling. There also exists devices to vibrate body members to improve blood circulation. Neither of these devices repeatedly raises and lowers a body part in order to utilizes gravity to move blood slowly both into and out of the region of the body.

### BRIEF SUMMARY OF THE INVENTION

A Blood Circulation Enhancement apparatus has a support mechanism with a mechanical raising device to slowly raise and lower a body member to accelerate blood circulation to a region of the body. The mechanical raising device is adjustable in height to allow the supported region of the body to move to a position below the level of the heart and then move to a position above the level of the heart. This process is then repeated for a period of time to allow gravity to enhance the natural blood circulation.

### DESCRIPTION

A Blood Flow Enhancement Apparatus is a mechanical device to repeatedly raise and lower a region of the body, such as a limb, up and down slowly, to accelerate blood circulation in and out of the region. The apparatus is vertically adjustable to allow the patient to set the height and the overall range of travel.

A Blood circulation Enhancement Apparatus may consist of a standing support structure; a sling, a gear motor; pulleys; a polyethylene line; and a control system to toggle the direction of the gear motor

The standing support structure may consist of a vertical support column attached to a support arm that extends over the patients body. Attached to the support arm are pulleys to guide the polyethylene line up and over the patient's body when the patient is in a sitting or resting position.

The polyethylene line is connected to a spool on the gear motor on one end and the suspended sling on the other end. The polyethylene line is routed through the pulleys to provide vertical support to the suspended sling.

The control system to toggle the direction of travel may consist of a flip-flop electrical circuit using a double pole—double throw relay in conjunction with a Normally-closed inductive proximity sensor and a Normally-open inductive proximity circuit. Two position-able metal collars are attached to the polyethylene line. The position of the collars can be adjusted to set the overall height and range of motion of the suspended sling. The proximity sensors are positioned on the vertical support column such that the polyethylene line passes the face of the sensors. When one of the metal collars triggers one of the proximity sensors, it toggles the flip-flop circuit and reverses the direction of the motor.

### DRAWINGS

FIG. 1 is a perspective view of a preferred embodiment of the apparatus

FIG. 2 is a circuit diagram of the flip-flop circuit to reverse the motor direction

### DETAILED DESCRIPTION OF PREFERRED EMBODIMENT

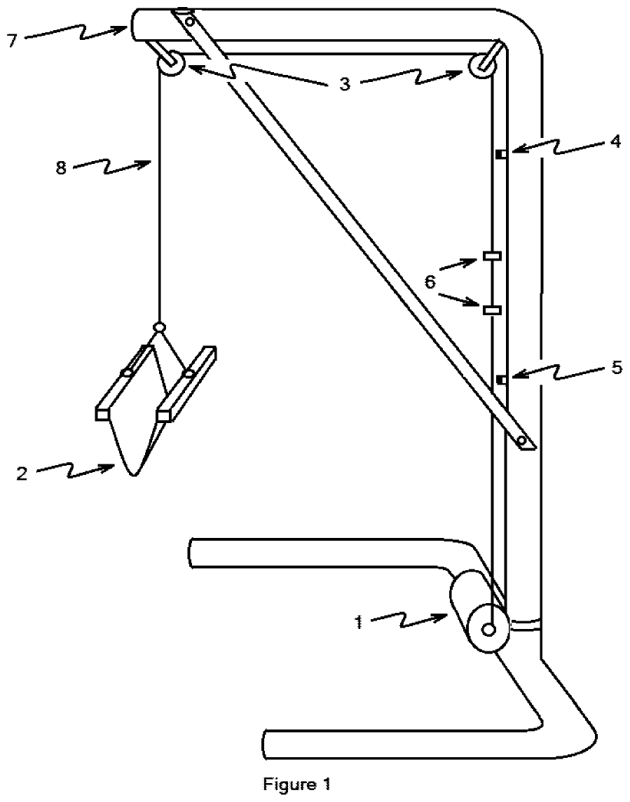

Turning to the drawings, there is illustrated in FIG. 1 an apparatus in accordance with the invention which comprises a gear motor 1 utilizing the shaft of the gear motor as the spool around which the polyethylene line 8 is wrapped. The gear motor 1 is rigidly attached to the vertical member of the support structure 7. The polyethylene line 1 is routed up and over the sitting or laying position of the patient by pulleys 3 attached to support structure 7. A sling 2 is attached to the opposite end of the polyethylene line 8.

Two metal clamping collars 6 are positioned on the vertical portion of the polyethylene line between the normally-open inductive proximity sensor 5 and the normally-closed inductive proximity sensor 4. The clamping collars 6 are positionable along the polyethylene line to allow the height to be adjusted to the height of the patient's body member. The distance between the collars can be adjusted to determine the overall vertical travel of the body member.

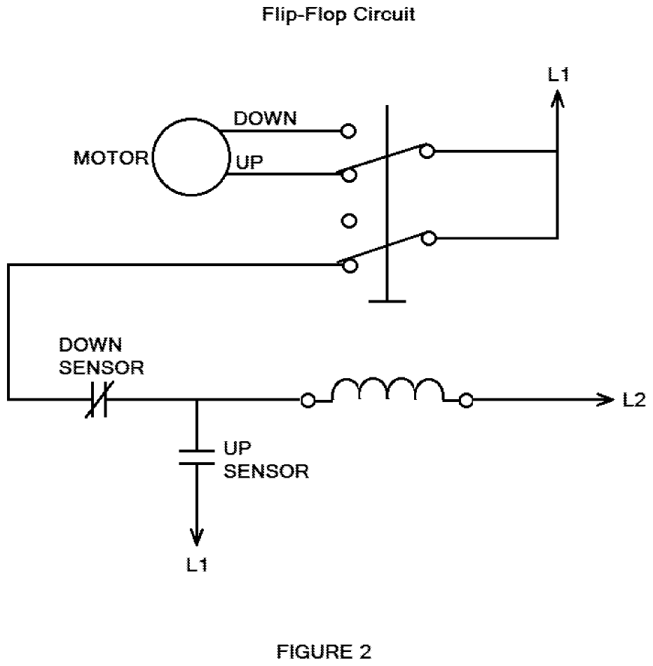

When electrical power is applied to the flip-flop circuit illustrated in FIG. 2, the gear motor 1 will initially rotate in a manner to lower the elevation of the sling 2. The gear motor 1 will continue rotating in a direction to lower the elevation of the sling 2 until the upper metal collar 6 enters the inductive sensing field of the normally-open sensor 4. The presence of metal in the inductive sensing field of the normally-open sensor 4 will close the output contact of the sensor and energize the coil of a double-pole double-throw relay, as illustrated in FIG. 2, thereby reversing the direction of the gear motor 1, which reverses the direction of travel of the sling 2. The direction of travel reverses from lowering the body member to raising the body member. The gear motor will continue to rotate in a direction to raise the sling 2 until the lower metal collar enters the inductive sensing field of the normally-closed sensor 5, at which time the gear motor will reverse, the sling will reverse direction from upward to downward. This cycle will repeat until electrical power is no longer applied.

1. An apparatus to repeatedly raise and lower a body member from an elevation above the heart to an elevation below the heart to enhance blood circulation in order to improve healing, performance, and aesthetics, in addition to other medical and health benefits.

2. An apparatus as in claim 1, comprising: a sling to support the body member; a support structure to suspend the sling; a gear motor to raise and lower the sling; and a flip-flop relay circuit to reverse direction.

3. A support structure as in claim 2, comprising: a vertical and a horizontal member; leg members; angle supports; pulleys; and a line connecting the sling to the gear motor as in claim 2.

4. A line as in claim 3, comprising a line passing through two metal collars that are position-able on the line to allow the patient to adjust the overall height and the range of travel of the sling as in claim 2.

5. A method to improve healing, performance, and aesthetics, in addition to other medical and health benefits by an apparatus that repeatedly raises and lowers a body member from an elevation above the heart to an elevation below the heart to enhance blood flow.
